(19) United States
(12) Patent Application Publication
(10) Pub. No.: US 2009/0054085 A1
(43) Pub. Date: Feb. 26, 2009

(54) Device and Method for Performing Location Association for Services

(75) Inventors: Wilfried Tobben, Bocholt (DE); Jorg Wienand, Bocholt (DE)

Correspondence Address: STAAS & HALSEY LLP, SUITE 700, 1201 NEW YORK AVENUE, N.W., WASHINGTON, DC, 20005, US

(73) Assignee: SIEMENS HOME AND OFFICE COMMUNICATION DEVICES GMBH, Munich (DE)

(21) Appl. No.: 12/083,085

(22) PCT Filed: Aug. 3, 2006
(86) PCT No.: PCT/EP2006/007722

§ 371 Date: Apr. 4, 2008

(51) Int. Cl. H04W 4/02

(52) U.S. Cl. 455/456.3

(57) ABSTRACT

A service call evaluation unit evaluates a service information and a piece of service call location information for the purpose of performing location association for services. A location/service association generator takes the service information and the service call location information as a basis for producing a location/service association, where a respective service has the location of the associated service call attributed to it. This allows inexpensive implementation of a self-organizing client/service system.

### BACKGROUND

Described below is a device and a method for performing location association for services and in particular to a device and a method for performing an association of geographical locations for services that are provided on the internet or World Wide Web (WWW).

The World Wide Web has revolutionized the options available for accessing an unimaginable abundance of information and services that can be available in electronic form as text data, audio data or image and video data in archived form or in real-time.

Information is exchanged over the internet on the basis of what is referred to as a client-server model. In this case individual clients address a query to centralized servers on the web which serve as data storage or as providers of services. Conventional web servers and in particular what are known as search engines analyze such a search query and respond thereto with a corresponding search result in more or less ordered form.

However, with the rapidly growing volume of data content and services on the internet or World Wide Web, such searches yield more and more hits, which greatly complicates the locating of a desired service.

In particular localized services such as e.g. a local pizza service, a local weather forecast or local radio and/or TV stations are usually available worldwide, even though they are only of interest to users from a particular region or at a particular place of origin. The infinite variety of these offered services therefore makes it difficult for the user to find the services relevant to “his” region or “his” geographical location.

For the providers of localized search services (e.g. “local.google.com”) there is scarcely any way at the present time of discovering, with little investment of effort or expense, the coverage areas of the locally offered services (e.g. internet radio transmitters). Thus, it has still been necessary until now for the providers of local services to register with one or more central databases of the search service. However, the providers of the search service are extremely reluctant to make this investment, in particular for small, still unknown providers of local services.

### SUMMARY

An aspect is to create a device and a method for performing a location association for services which enables localized services to be identified in a simple and inexpensive manner.

A service call evaluation unit accordingly evaluates a service call in order to generate service information and service call location information, the service information containing a called service and the service call location information a place of origin of the service call or of the client sending the service call. A location/service association generator thereupon generates a location/service association between at least one service and associated locations, the service information specifying a respective service and the service call location information the associated location. In this way the offered service is not associated with its actual location, but rather with a geographical location of users calling the service. This results in a self-organizing location estimation which operates independently of existing localized information and delivers extremely useful location/service associations.

The location/service association can have, for example, an association factor which weights a particular association. This can be, for example, a service call count, a service call duration and/or a service call frequency for service calls having identical service information and identical service call location information. Supplementary information describing the service call in more detail can also be generated by the service call evaluation unit, the association factor additionally being specified by the supplementary information. As a result of such a weighting of the respective associations the location/service association gains an increased information content and improved significance.

For example, an assessment unit can assess the location/service association in order to generate an assessed location/service association, the assessment being performed e.g. as a function of the association factor and representing a reordering or classification, with at least one further association parameter being assigned to the assessed location/service association. A location/service association assessed in this way therefore possesses a particularly high location relevance and can already be output as a search result in response to a search query.

A selection call evaluation unit for evaluating a selection call for an assessed location/service association can also be provided for generating selection call location information containing a place of origin of the selection call, the assessment unit assessing the location/service association as a function of the selection call location information AOI. More precisely, a search query can be analyzed with regard to its place of origin and a search result to be output accordingly being adapted geographically using the place of origin of the search query. A geographical filter function can be implemented in this way, thereby further improving the relevance of a hit list.

With regard to the method, a service call is initially evaluated in order to generate service information containing a called service and service call location information containing a place of origin of the service call. A location/service association between the at least one service and associated locations is then carried out, the service information specifying a respective service and the service call location information the associated location in each case. Accordingly , a geographical location of an offered service is thus determined more precisely not by its actual location, but by the place of origin(s) of the clients calling the service. This results in a self-organizing client-server system which assigns respective geographical locations to offered services in a simple and inexpensive way.

### BRIEF DESCRIPTION OF THE DRAWINGS

These and other aspects and advantages will become more apparent and more readily appreciated from the following description of an exemplary embodiment, taken in conjunction with the accompanying drawings of which:

FIG. 1 is a block diagram of a simplified representation of a client-server system;

FIG. 2 is a simplified block diagram of the device for performing a location association for services;

FIG. 3A is a block diagram of a network;

FIGS. 3B and 3C are tables providing a simplified representation to illustrate a location association for services; and

FIG. 4 is a simplified flowchart to illustrate a method for performing a location association for services.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

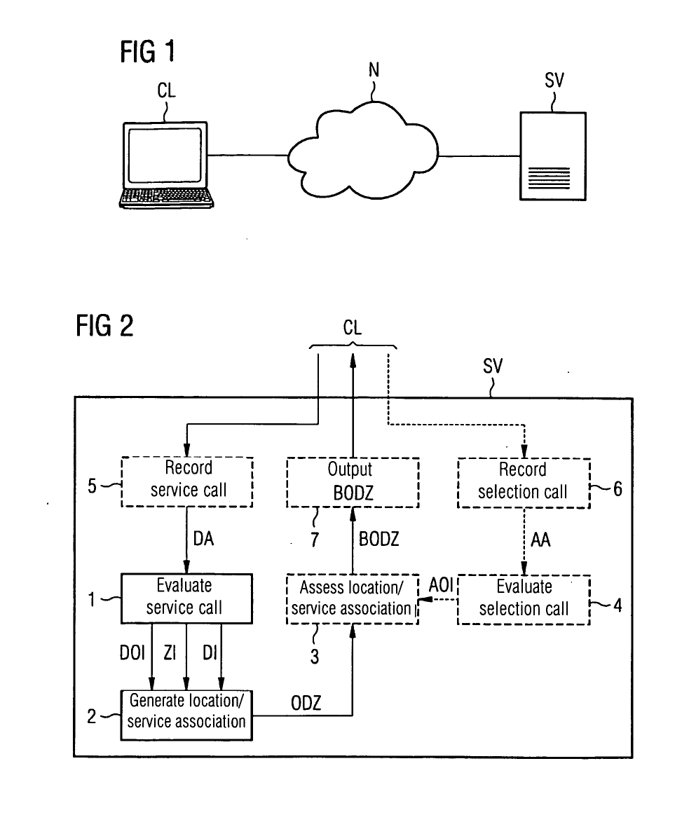

FIG. 1 shows a simplified representation of a client-server system as a self-organizing client-server system, associates and stores all connections between a region or location of the user or client CL and a service provided by a server SV which is called by the users or clients CL.

According to FIG. 1 the client CL is connected to the server SV via a network N. The network N is, for example, a packet-switching network and in particular an IP-based network (IP: Internet Protocol) or the so-called internet. Needless to say, alternative networks can also be used.

The client CL can represent for example a PC, PDA (Personal Digital Assistant), a cell phone, a smartphone, an internet radio, a set-top box or some other wireless or wired telecommunications terminal device. The telecommunications terminal or client CL can have a browser or a browser-like application by which the terminal can access the internet or the network N and the server SV attached thereto. Browsers of this type include for example internet Explorer™ from Microsoft, Netscape Navigator™ from Netscape Communication Corporation or Safari™ from Apple Computer Incorporation.

Via a browser of this type a homepage implemented by a server SV, for example, can be called or selected by a corresponding search engine, a search query or a selection call AA being input in a corresponding input field by a user on the client side and a corresponding hit list or search result being sent by the search engine implemented in the server SV. A respective address of the homepage can of course also be input directly, in which case, however, it needs to be ensured that the server SV can record or register this call by the device.

In this case the server SV, in which, for example, the device for performing a location association for services as well as the associated method are implemented, performs in particular an association of services provided on the internet as a function of a geographical location of associated calls for the service.

The geographical place of origin of the user or client CL is determined automatically on the basis of suitable criteria such as, for example, an IP address, a telephone number (in particular a prefix) etc. for each service call of a service provided in the network N. Since the geographical location of the server SV providing the service often does not tally with the location of the offered service, this is not taken into consideration. Rather, the geographical location of the user or client CL calling a respective offered service is associated with the service in a list or table for implementing a location/service association. By an estimation of this kind for a location/service association, the services provided globally in the network N can then be ordered or sorted also on a location-dependent basis. The relevance of hit lists in particular in the case of a respective search query or selection call is thereby significantly increased, while at the same time the costs are minimal since the system is self-organizing and requires no maintenance overhead whatever.

FIG. 2 shows a simplified block diagram of a device for performing a location association for services, as can be implemented in a server SV.

According to FIG. 2, the device for performing a location association for services provided in the network N has a service call evaluation unit 1 for evaluating a service call DA which generates at least service information DI and service call location information DOI. In this case the service information DI contains at least a unique identification of the called service, such as, for example, a URI (Uniform Resource Identifier) or a domain name. The service call location information (DOI), on the other hand, contains at least one identification of a place of origin of the service call DA or of the user or client C sending the service call DA. Service call location information of this kind can in turn be an IP address in the network N such as, for example, a URI of the dial-in node or a prefix number of the terminal. The service call location information DOI can, however, also have already further resolved location information which indicates for example a specific geographical location, a specific geographical region or a specific geographical country.

Furthermore, in addition to the service information DI and the service call location information DOI, the service call evaluation unit 1 can also derive and generate supplementary information ZI from the service call DA. Supplementary information ZI of this kind can be for example the client-side inclusion of a respective service in a favorites list etc. In this case this type of supplementary information ZI must be supported by the client CL and be made available to the server SV via the network N. In this connection a usage period of a service called in each case can be recorded for example on the client side and made available as supplementary information ZI to the server S. Basically, however, such a recording of the usage period of a service can also be implemented in the server SV or in the service call evaluation unit 1, in which case service call end information must be present and evaluated.

The service information DI together with the service call location information DOI and the optional supplementary information ZI are then supplied to a location/service association generator 2 which generates a location/service association ODZ between at least one service and associated locations, the service information DI specifying a respective service and the service call location information DOI the associated location in the location/service association ODZ. In the simplest case this is a single association, e.g. DI<->DOI.

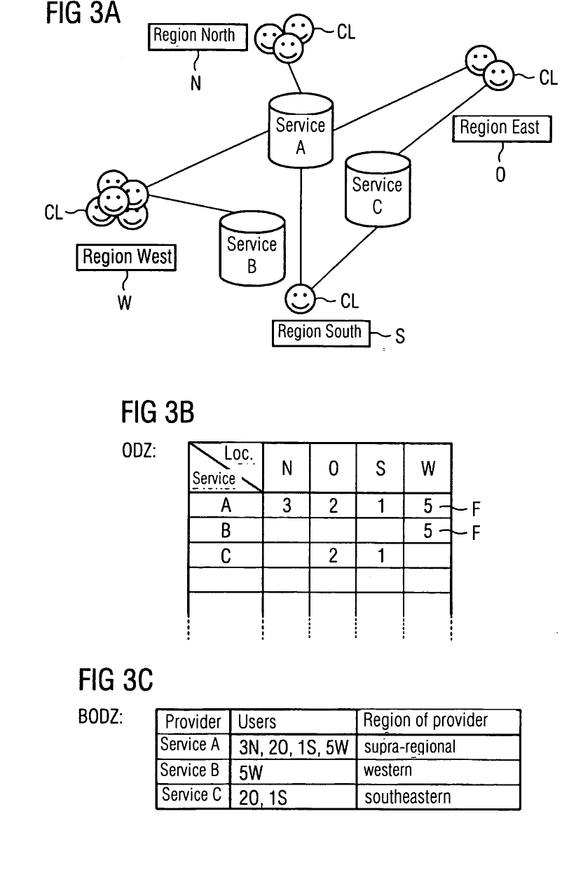

In order to illustrate the performing of a location association for services, reference is made to FIGS. 3A to 3C, in which for example the services A, B and C represent internet radio transmitters which are listened to or received by different users or associated clients CL.

According to FIG. 3A, the IP-based radio transmitter or service A is accordingly called and listened to by five clients CL in a western region W of, for example, a country (such as Germany). The service call evaluation unit 1 accordingly records five service calls which have as service information DI=“Service A” and contain as service call location information DOI=“Region West”. The location/service association generator 2 accordingly associates the locations W for the western region five times with the “Service A”. In the same way a client CL from the southern region S, two clients CL from the eastern region 0 and three clients CL from the northern region N access the radio transmitter or service A.

The corresponding location/service associations ODZ are shown in simplified form in a table according to FIG. 3B. Here, the services A, B, C, . . . called in each case are listed in a left-hand column and the geographical locations or regions N, 0, S, W, . . . possible in each case are given in a first row. At the crossover points of the association matrix there can then be found, for example, a number of service calls for a respective service from a respective region or from a respective geographical location. The location/service association ODZ can thus have an association factor F which weights a respective association between an offered service and an associated location.

Full evaluation of the system shown in FIG. 3A results in the location/service association matrix shown in FIG. 3B, wherein in addition the service B is called by five users from a western region W and a service C is called by two users from an eastern region 0 and one user or client CL from a southern region S.

Although a service call count can be noted as the association factor in the location/service association table ODZ in FIG. 3B, it is also possible to store e.g. a service call duration and/or a service call frequency of service calls DA with identical service information DI and identical service call location information DOI. This results in turn in a certain weighting of the associations stored in the location/service association table ODZ.

Accordingly, when a period of time is selected as the association factor F, the time during which a respective user or client CL listens to a respective service or radio transmitter is stored. On the other hand, when the service call frequency is chosen as the association factor F, a ratio between a service call count per time unit, i.e. per hour or per day, can be stored. Other association factors F are, of course, also conceivable and in particular association factors which, for example, continue to be stored in the location/service association ODZ using the optionally transmitted supplementary information ZI such as, for example, a favorites list. In this case an association factor F can be determined in particular using a formula.

According to FIG. 2, an assessment unit 3 can also be provided for the purpose of assessing the thus established location/service association ODZ and for the purpose of generating an assessed location/service association BODZ. An assessment unit 3 of this kind can now generate an assessed location/service association BODZ with additional information, in particular using the association factors F.

FIG. 3C shows an assessed location/service association table BODZ of this kind, wherein a classification has been performed on the basis of the association factors F and the assessed location/service association BODZ now has at least one further association parameter. According to FIG. 3C, this is the region of the service provider, wherein, based on evaluation of the most diverse service calls, the service A is classified as “supra-regional”, the service B as “western” and the service C as “southeastern”. A location/service association BODZ of this kind assessed and classified according to locations or regions of the provider could already be made available to respective users as relevant information or as a search result.

In addition, however, a reordering of the location/service association ODZ can be output as the assessed location/service association BODZ, wherein, for example, the absolute majority of or the relatively most frequently called services appear right at the top in a list BODZ, while the less frequently called services appear further down.

According to FIG. 2, a selection call evaluation unit 4 can in particular be provided in addition for the purpose of evaluating a selection call or a search query AA for an assessed location/service association, which selection call evaluation unit generates selection call location information AOI, the assessment unit 3 assessing the location/service association ODZ as a function of the selection call location information AOI. In this case the selection call location information AOI in turn reflects, like the service call location information DOI, a respective place of origin of a user or client CL sending the call. In this way the location/service association ODZ shown in FIG. 3B can be assessed alternatively or additionally using the selection call location information AOI or the place of origin of a search query.

An assessment of this kind can in turn be a reordering as a function of the place of origin of the querying client CL, wherein, for example, services with an identical location association to the selection call AA are listed right at the top in the assessed location/service association table BODZ. For a client CL sending a selection call AA from the western region W, therefore, the location/service association shown in FIG. 3B would remain unchanged.

Furthermore, location filtering can also be performed as a function of the selection call location information AOI, in which case in the above-cited example (i.e. search query by CL from W) only the services A and B would be output as assessed location/service association and the service C is masked out due to the filtering effect. It goes without saying that arbitrary further assessment criteria and schemes are possible in addition to the above-cited assessment criteria.

According to FIG. 2, provision can also be made for a service call recording unit 5 for recording service calls DA from querying clients CL, a selection call recording unit 6 for recording selection calls from querying clients CL and an output unit 7 for outputting the assessed location/service association BODZ to a querying client CL in each case.

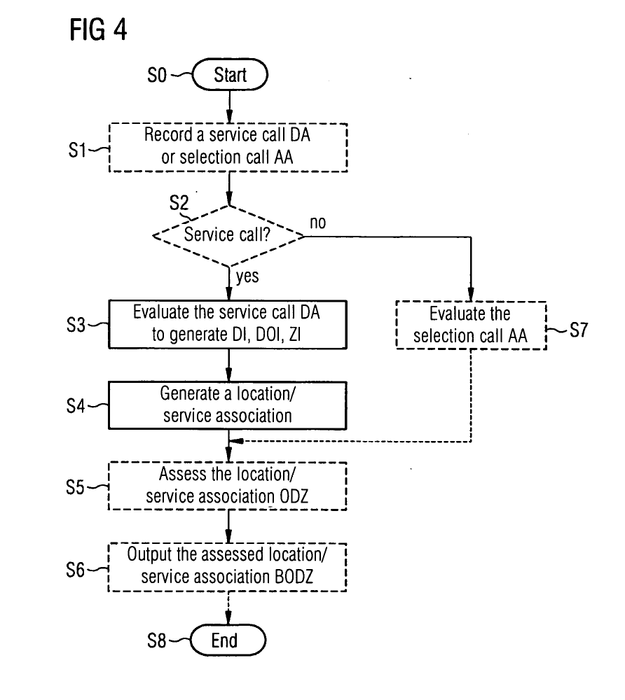

FIG. 4 shows a simplified flowchart for illustrating essential operations in the method for performing a location association for services.

After a start in step S0, a service call DA or a selection call AA can initially be recorded in a step S1. In this case the service call DA represents the calling of an offered service such as, for example, an IP radio or TV station by a calling client CL. On the other hand, a selection call AA represents a call for a service selection or a so-called search query, with a user of a client CL requesting, for example, a hit list of local services or local IP radio or TV stations that are relevant to him.

In a further optional step S2 a query can take place to determine whether the recorded message is a service call or a selection call. If it is established in step S2 that the message is a service call DA, a branch is made to step S3. If, on the other hand, it is a selection call AA, a branch is made to step S7.

In step S3 the service call DA is now performed in order to generate at least one item of service information DI and one item of service call location information DOI. Supplementary information ZI can also be generated. The service information DI contains for example the domain name or the IP address of the called service or a corresponding definition. The service call location information DOI contains a place of origin of the service call DA which is formed in a packet-switching network, for example, from the IP address of the querying client CL. In a circuit-switching network this place of origin can also be derived from a subscriber number and in particular from the prefix of an associated telephone number of the client CL. In addition the supplementary information ZI can include user habits such as, for example, a usage period or the inclusion of the called service in a favorites list.

In the following step S4 a location/service association ODZ is now performed between the at least one service A, B and C and associated geographical locations or regions N, 0, S, W, as described with reference to FIGS. 3A to 3C. In this case the service information DI specifies a respective service A, B, C and the service call location information the associated location N, 0, S, W in each case. In this way a location/service association table according to FIG. 3B is obtained, wherein a respective service is not associated with its actual location, at which e.g. the associated server is installed or at which a respective dial-in node of the network N is situated; instead, the location of a respective user or client CL that calls the service is associated with the service. What is obtained is a self-organizing client-server system which estimates and provides a location/service association ODZ at minimal cost.

In an optional step S5 an assessment of the location/service association ODZ can additionally be performed, wherein, as already described in the foregoing, the existing location/service association can be, for example, reordered, weighted, or provided with additional parameters.

This assessed location/service association BODZ can subsequently be output in a step S6, with the method ending in a step S8.

If it was established in step S2 that the message is a selection call AA, e.g. a search query, an evaluation of the selection call AA or a search query is performed in a step S7. In this case an item of selection call location information AOI containing a place of origin of the selection call AA is generated, in which case a branch is subsequently made to step S5 and the assessment of the location/service association ODZ can be performed alternatively or additionally also as a function of the generated selection call location information AOI. The selection call location information in turn represents a geographical location or a geographical region of the user or client CL sending the call, which can be derived from, for example, an associated IP address or an associated telephone number and in particular a local area code, i.e. a prefix number.

The additional assessment of the location/service association table ODZ made possible thereby can be, for example, a reordering or filtering as a function of the geographical location of the client CL sending the selection call AA.

In this way search results or hit lists with greatly improved location-dependent relevance are obtained, which search results or hit lists are especially suitable in particular for selecting local services.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to an IP radio transmitter as the service. It is not, however, restricted thereto and includes in the same way also arbitrary other services. The present invention has also been described with reference to an IP-based network N. It is not, however, restricted thereto and includes in the same way also other packet-switching or circuit-switched networks as well as combinations thereof. It will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-22. (canceled)

23. A device for performing a location association for services having
a service call evaluation unit evaluating a service call and generating service information and service call location information; and
a location/service association generator generating a location/service association between at least one service and associated locations, the service information relating to a respective called service and the service call location information specifying the associated location, including a place of origin of the service call.

24. The device as claimed in claim 23, wherein the location/service association has an association factor which weights a respective association.

25. The device as claimed in claim 24, wherein said service call evaluation unit further generates supplementary information providing details of the service call, including specifying the association factor.

26. The device as claimed in claim 25, wherein the association factor represents at least one of a service call count, a service call duration, a service call frequency of service calls with identical service information and identical service call location information and an inclusion in a favorites list.

27. The device as claimed in 26, further comprising an assessment unit assessing the location/service association and generating an assessed location/service association.

28. The device as claimed in claim 27, wherein said assessment unit provides an assessment of the location/service association as a function of the association factor.

29. The device as claimed in claim 28, wherein the assessment of the location/service association represents a reordering.

30. The device as claimed in claim 29, wherein the assessment of the location/service association represents a classification, and the location/service association receives at least one association parameter as part of the assessment.

31. The device as claimed in claim 30,
further comprising a selection call evaluation unit evaluating a selection call for an assessed location/service association and generating selection call location information containing a place of origin of the selection call, and
wherein said assessment unit assesses the location/service association as a function of the selection call location information.

32. The device as claimed in claim 31, wherein the services represent IP-based services for an IP-based network.

33. The device as claimed in 32, further comprising:
a service call recording unit recording service calls from clients;
a selection call recording unit recording the selection call from a querying client; and
an output unit outputting the assessed location/service association to the querying client.

34. A method for performing a location association for services, comprising:
evaluating a service call for generating service information containing a called service, and service call location information containing a place of origin of the service call; and
generating a location/service association between at least one service and associated locations, the service information specifying a respective service and the service call location information specifying a respective associated location in each case.

35. The method as claimed in claim 34, further comprising, when the location/service association is generated, determining an association factor which weights a respective association.

36. The method as claimed in claim 35, further comprising, when the service call is evaluated, determining supplementary information which describes details of the service call and specifying the association factor.

37. The method as claimed in claim 36, wherein the association factor represents at least one of a service call count, a service call duration, a service call frequency of service calls with identical service information and identical service call location information and an inclusion in a favorites list.

38. The method as claimed in 37, further comprising assessing the location/service association for generating an assessed location/service association.

39. The method as claimed in claim 38, wherein said assessing is performed as a function of the association factor.

40. The method as claimed in claim 39, wherein said assessing of the location/service association represents a reordering.

41. The method as claimed in claim 40, wherein said assessing of the location/service association represents a classification and the location/service association receives at least one association parameter during said assessing.

42. The method as claimed in claim 41,
further comprising evaluating a selection call for an assessed location/service association for generating selection call location information containing a place of origin of the selection call, and
wherein said assessing of the location/service association is performed as a function of the selection call location information.

43. The method as claimed in claim 42, wherein the services represent Internet protocol-based services for an Internet protocol-based network.

44. The method as claimed in claim 43, further comprising:
recording a service call or selection call from a querying client; and
outputting the assessed location/service association to the querying client.
